(19) United States
(12) Patent Application Publication
(10) Pub. No.: US 2006/0178925 A1
(43) Pub. Date: Aug. 10, 2006

(54) System for docketing litigation events

(75) Inventors: Timothy C. Meece, Burr Ridge, IL (US); Mark T. Banner, Warrenville, IL (US); Joseph William Costello JR., Frederick, MD (US); Aimee M. Boss, Chicago, IL (US)

Correspondence Address: BANNER & WITCOFF, LTD., TEN SOUTH WACKER DRIVE, SUITE 3000, CHICAGO, IL, 60606, US

(73) Assignee: Banner & Witcoff, Ltd., Chicago, IL (US)

(21) Appl. No.: 11/051,532

(22) Filed: Feb. 4, 2005

(51) Int. Cl. G06F 15/02

(52) U.S. Cl. 705/9

(57) ABSTRACT

Litigation-docket software may be used by teams of litigation attorneys for entering, maintaining, and viewing information about litigation events. Litigation-docket entries may contain information, such as start and end times and a responsible attorney, about litigation events, such as court hearings, brief-due dates, depositions, and the like. After a litigation-docket entry is created, instances (i.e., copies) of the litigation-docket entry are sent to members of the litigation team. A recipient may accept, reject, or tentatively accept the litigation-docket-entry instance. Recipients may request that the entry creator make changes to information within the litigation-docket entry. Upon the entry creator making such a change, instances of the revised litigation-docket entry will be sent to litigation-team members. A verification utility may be used to verify that litigation-team members have litigation-docket-entry instances that are consistent with one another. A user may customize the user's view of their litigation-docket entries.

### TECHNICAL FIELD

The invention relates to a system for docketing litigation events for a team of litigation attorneys.

### BACKGROUND OF THE INVENTION

Complex litigation, such as a patent-infringement lawsuit, is often handled by a team of attorneys. The attorneys on a team may work in offices located in multiple cities that are in different time zones. When a litigation-related appointment is scheduled and litigation-team members are in different time zones, scheduling errors may occur due to incorrect time-zone conversion of a scheduled appointment time.

Conventional calendaring software, such as Microsoft® Outlook®, is relatively limited with respect to providing functionality that is specifically intended for entering, maintaining, and viewing a docket of litigation events for a team of litigation attorneys. For instance, user interfaces (UIs) for conventional calendaring software typically do not provide fields for client and matter reference numbers to be associated with litigation-docket entries. UIs for conventional calendaring software also typically do not display start and end times in multiple time zones to minimize time-zone conversion errors made while entering start and end times of a litigation event into the calendaring software. UIs for conventional calendaring software also typically do not provide input fields for litigation-specific information, such as a responsible attorney for a litigation event. UIs for conventional calendaring software typically do not facilitate inserting into litigation-docket entries links to documents contained within a document-management system. Finally, conventional calendaring software typically does not provide any means for verifying that multiple copies (also referred to as instances) of litigation-docket entries are consistent with one another.

Litigation-docket software that provides the types of functionality discussed above would be desirable.

### SUMMARY OF THE INVENTION

In accordance with embodiments of the invention, litigation-docket software may be used by a team of litigation attorneys for entering, maintaining, and viewing information about litigation events. Litigation-docket entries may contain information, such as start and end times and a responsible attorney, about litigation events, such as court hearings, brief-due dates, depositions, and the like. After a litigation-docket entry is created, instances (i.e., copies) of the litigation-docket entry are sent to members of the litigation team. A recipient may accept, reject, or tentatively accept the litigation-docket-entry instance. Recipients may request that the entry creator make changes to information within the litigation-docket entry. Upon the entry creator making such a change, instances of the revised litigation-docket entry will be sent to litigation-team members. A verification utility may be used to verify that litigation-team members have litigation-docket-entry instances that are consistent with one another. A user may customize the user's view of their litigation-docket entries.

Litigation-docket software in accordance with embodiments of the invention advantageously allows users to schedule litigation events, including reminders, for a litigation team in the team members' respective calendars. Users may select client-reference information and matter-reference information via an interface to a document-management system, such as Interwoven DeskSite®.

For litigation events, such as court appearances, depositions, and other appointments, the litigation-docket software may display the time of the litigation event in multiple time zones to help prevent users from scheduling events incorrectly due to time-zone-conversion errors.

Litigation-docket-entry-instance recipients may be denied permission to make changes to information within litigation-docket-entry instances so that only the entry's creator (and optionally a litigation-docket administrator) may change the information. To initiate such a change, a recipient may send a change request to the entry creator. Upon the entry creator revising the entry, instances of the revised entry are sent to team members. In this way, existence of inconsistent litigation-docket-entry instances is advantageously reduced relative to allowing recipients to change information within their own instances of litigation-docket entries.

Additional features and advantages of the invention will be apparent upon reviewing the following detailed description.

### BRIEF DESCRIPTION OF THE DRAWINGS

FIG. 1 depicts a computer system in which embodiments of the invention may be implemented.

FIG. 2 is a schematic diagram of a system that disseminates litigation-docket information in accordance with embodiments of the invention.

FIG. 3 depicts a user-interface form for entering litigation information in accordance with embodiments of the invention.

FIGS. 4 and 5 depict a litigation-docket entry's Notes tab and Notes field, respectively, in accordance with embodiments of the invention.

FIG. 6 depicts various user-interface controls, in accordance with embodiments of the invention, that a recipient of a litigation-docket-entry instance may use for accepting, rejecting, tentatively accepting, or proposing a new time for the litigation-docket entry.

FIGS. 7 and 8A-8C are smart-phone screen shots that show a received litigation-docket entry in accordance with embodiments of the invention.

FIG. 9 depicts a Request-Changes button within a portion of a displayed litigation-docket-entry instance in accordance with embodiments of the invention.

FIG. 10 displays a litigation-docket-entry change-request form in accordance with embodiments of the invention.

FIG. 11 depicts a form for inputting search criteria for finding litigation-docket entries in accordance with embodiments of the invention.

FIG. 12 depicts a flowchart of exemplary steps for verifying the litigation-docket-entry instances are consistent with one another in accordance with embodiments of the invention.

FIG. 13 depicts an example of an exception report generated by a verification utility in accordance with embodiments of the invention.

FIGS. 14A and 14B depict a flowchart of exemplary steps for docketing litigation information for a litigation event in accordance with embodiments of the invention.

FIGS. 15-28 are example screen shots showing how a user can customize their view of their litigation-docket entries in accordance with embodiments of the invention.

### DETAILED DESCRIPTION OF THE INVENTION

I. Introduction

Litigation-docket software, in accordance with embodiments of the invention, may be used by teams of litigation attorneys for entering, maintaining, and viewing information about litigation events. Litigation-docket entries may contain information, such as start and end times and a responsible attorney, about litigation events, such as court hearings, brief-due dates, depositions, and the like.

A litigation-team member who creates a litigation-docket entry for a litigation event is referred to as an entry creator. After the entry creator enters pertinent information about the litigation event, an instance (i.e., a copy) of the litigation-docket entry is sent to members of the litigation team, which may include a litigation-docket administrator. In a manner similar to receiving and accepting or rejecting standard Outlook® personal information manager (PIM) meeting requests, a recipient of a litigation-docket-entry instance may accept, reject, or tentatively accept the litigation-docket-entry instance.

Recipients may be denied permission to change information within a litigation-docket-entry instance so that recipients request that the entry creator make changes to information within the litigation-docket entry. Upon the entry creator making such a change, instances of the revised litigation-docket entry are sent to litigation-team members.

A verification utility may be used to verify that litigation-team members have litigation-docket-entry instances that are consistent with one another. The verification utility may scan litigation-docket entries to try to find two instances of a litigation-docket-entry that have different start times, dates, and/or durations. When an out-of-sync situation of this type is found, a report may be generated and forwarded to appropriate litigation-team members so that an incorrect instance of an entry may be corrected.

A user may customize the user's view of their litigation-docket entries. For example, a user may specify that only the following type of litigation-docket-entry instances be displayed in the following manner: litigation-docket entries that start on or after the current date should be displayed grouped by client-matter reference numbers and sorted chronologically within each group of entries for a particular client-matter reference number.

II. Operating Environment

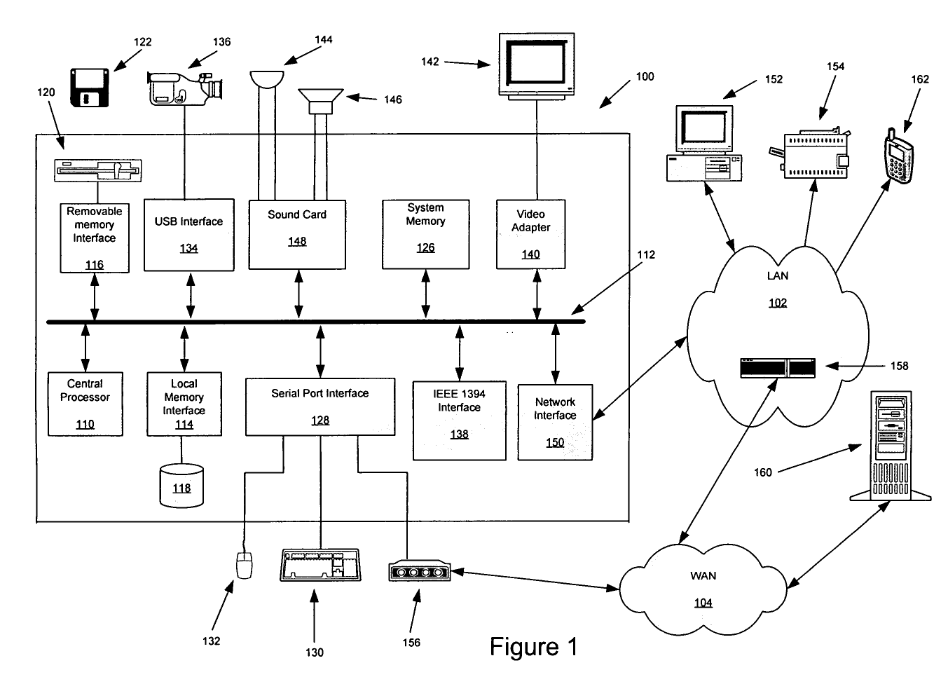

FIG. 1 illustrates an exemplary computer system in which embodiments of the invention may be implemented. A computer 100 is connected to a local area network (LAN) 102 and a wide area network (WAN) 104. Computer 100 includes a central processor 110 that controls the overall operation of the computer and a system bus 112 that connects central processor 110 to the components described below. System bus 112 may be implemented with any one of a variety of conventional bus architectures.

Computer 100 can include a variety of interface units and drives for reading and writing data or files. In particular, computer 100 includes a local memory interface 114 and a removable memory interface 116 respectively coupling a hard disk drive 118 and a removable memory drive 120 to system bus 112. Examples of removable memory drives include magnetic disk drives and optical disk drives. Hard disks generally include one or more read/write heads that convert bits to magnetic pulses when writing to a computer-readable medium and magnetic pulses to bits when reading data from the computer readable medium. A single hard disk drive 118 and a single removable memory drive 120 are shown for illustration purposes only and with the understanding that computer 100 may include several of such drives. Furthermore, computer 100 may include drives for interfacing with other types of computer readable media such as magneto-optical drives.

Unlike hard disks, system memories, such as system memory 126, generally read and write data electronically and do not include read/write heads. System memory 126 may be implemented with a conventional system memory having a read only memory section that stores a basic input/output system (BIOS) and a random access memory (RAM) that stores other data and files.

A user can interact with computer 100 via a variety of input devices. FIG. 1 shows a serial port interface 128 coupling a keyboard 130 and a pointing device 132 to system bus 112. Pointing device 132 may be implemented with a hard-wired or wireless mouse, track ball, pen device, or similar device.

Computer 100 may include additional interfaces for connecting peripheral devices to system bus 112. FIG. 1 shows a universal serial bus (USB) interface 134 coupling a video or digital camera 136 to system bus 112. An IEEE 1394 interface 138 may be used to couple additional devices to computer 100. Furthermore, interface 138 may configured to operate with particular manufacture interfaces such as FireWire developed by Apple Computer and i.Link developed by Sony. Peripheral devices may include touch sensitive screens, game pads scanners, printers, and other input and output devices and may be coupled to system bus 112 through parallel ports, game ports, PCI boards or any other interface used to couple peripheral devices to a computer.

Computer 100 also includes a video adapter 140 coupling a display device 142 to system bus 112. Display device 142 may include a cathode ray tube (CRT), liquid crystal display (LCD), field emission display (FED), plasma display or any other device that produces an image that is viewable by the user. Sound can be recorded and reproduced with a microphone 144 and a speaker 146. A sound card 148 may be used to couple microphone 144 and speaker 146 to system bus 112.

One skilled in the art will appreciate that the device connections shown in FIG. 1 are for illustration purposes only and that several of the peripheral devices could be coupled to system bus 112 via alternative interfaces. For example, video camera 136 could be connected to IEEE 1394 interface 138 and pointing device 132 could be connected to USB interface 134.

Computer 100 includes a network interface 150 that couples system bus 112 to LAN 102. LAN 102 may have one or more of the well-known LAN topologies and may use a variety of different protocols, such as Ethernet. Computer 100 may communicate with other computers and devices connected to LAN 102, such as computer 152 and printer 154. Computers and other devices may be connected to LAN 102 via twisted pair wires, coaxial cable, fiber optics or other media. Alternatively, radio waves may be used to connect one or more computers or devices to LAN 102.

A wide area network 104, such as the Internet, can also be accessed by computer 100. FIG. 1 shows a modem unit 156 connected to serial port interface 128 and to WAN 104. Modem unit 156 may be located within or external to computer 100 and may be any type of conventional modem, such as a cable modem or a satellite modem. LAN 102 may also be used to connect to WAN 104. FIG. 1 shows a router 158 that may connect LAN 102 to WAN 104 in a conventional manner. A server 160 is shown connected to WAN 104. Of course, numerous additional servers, computers, handheld devices, personal digital assistants, telephones and other devices, such as a smart phone 162, may also be connected to WAN 104.

The operation of computer 100 and server 160 can be controlled by computer-executable instructions stored on a computer-readable medium. For example, computer 100 may include computer-executable instructions for transmitting information to server 160, receiving information from server 160 and displaying the received information on display device 142. Furthermore, server 160 may include computer-executable instructions for transmitting hypertext markup language (HTML) or extensible markup language (XML) computer code to computer 100.

A personal information manager (PIM), including, but not limited to, Microsoft® Outlook® or Lotus Notes®, may be executed by computer 100. PIM is a type of software application designed to help users organize random pieces of information. Most PIMs enable a user to enter various kinds of textual notes—reminders, lists, dates—and to link these bits of information together in useful ways. PIMs may include calendar, scheduling, and calculator programs.

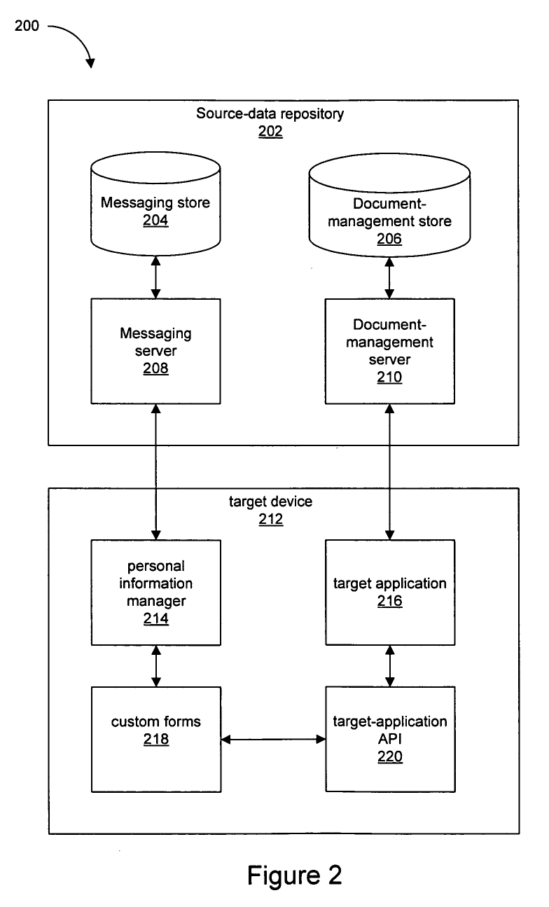

FIG. 2 is a schematic diagram of a system 200 that disseminates litigation-docket information in accordance with embodiments of the invention. The system 200 includes a source-data repository 202 and a target device 212. Messaging server 208 may be any suitable messaging server, including, but not limited to, a server running Microsoft® Exchange, Novell® GroupWise®&, or Lotus Notes®, and may store messaging-system data in messaging store 204.

Document-management server 210 may be any suitable document-management-system server, including, but not limited to, a server running Interwoven® Worksite® or Hummingbird®, and may store document-management-system data in document-management store 206.

Target device 212 may include a personal information manager (PIM) 214 that may exchange messaging data, including, but not limited to e-mail messages and litigation-docket entries, with messaging server 208. The PIM 214 may obtain litigation-specific user-interface forms from custom forms 218 and display the user-interface forms to a user of the PIM. The target device 212 may be a smart phone 162, personal digital assistant, laptop computer, or other suitable computer device.

Target application 216 may be a document-management-system client component, such as Interwoven® Desksite® desktop client, and may expose an application programming interface (API), which is depicted in FIG. 2 as the target-application API 220.

The messaging server 208 adds a workflow component to the system 200 by acting as a “push” agent, which may send litigation-docket entries to a variety of target devices 212, including but not limited to a PIM, a personal digital assistants, a laptop computer, a personal computer, and any other suitable computer device.

In accordance with embodiments of the invention, litigation-docket entries may be “pushed” in the format of an electronic calendar that is generated and emailed periodically or available for download. In this way, pertinent litigation-docket entries may be provided to external users who are not part of a particular law firm without the external users needing access to the law firm's computer systems. Litigation-docket entries may also be provided to such external users via an extranet calendar component. In addition to these ways of delivering litigation-docket-entries, the entries' source format could reside in a variety of calendar products, and those products may provide access to the data using messaging options, such as the generation and emailing of a calendar periodically, or may be integrated with messaging systems or extranet products. Delivery could therefore be a push technology using any conventional messaging format, a view technology where a custom calendar exists in a space that can be accessed via a client-server-type calendar product, perhaps using browser technology, including, but not limited to Microsoft Internet Explorer, Mozilla, and Netscape, to view the data. Another approach uses a database, such as Access or Structured Query Language (SQL), to host the data, provides custom Web views, and uses a report engine, such as the Crystal report engine, to provide views directly to the data or to generate, automatically and/or on demand, a litigation-docket-entry report that may be downloaded or emailed from within a database program.

III. Creating a Litigation-Docket Entry

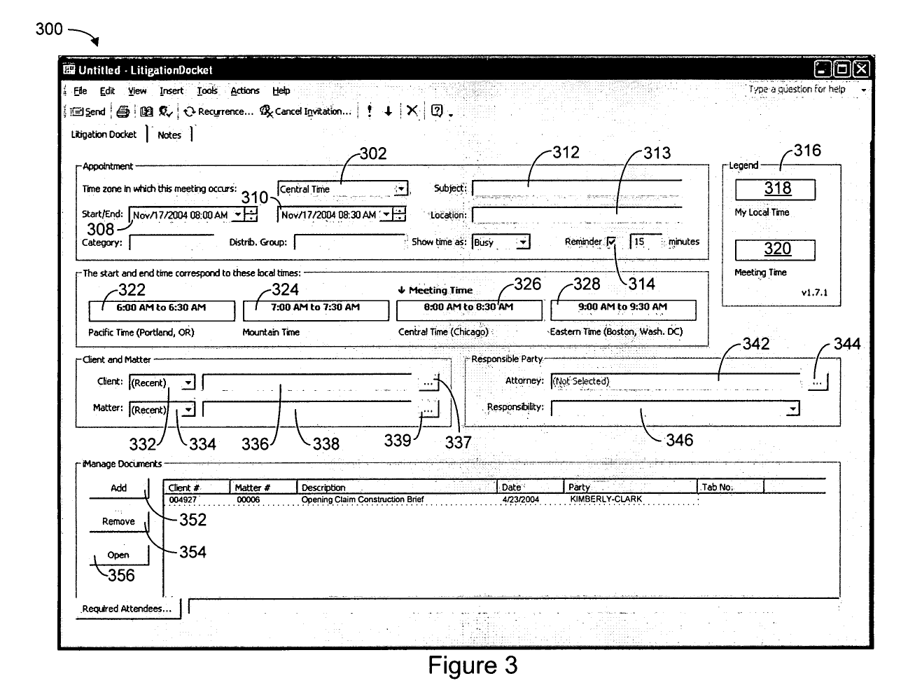

In accordance with embodiments of the invention, a custom (i.e., non-standard) entry-creation form 300 (FIG. 3) may be used for creating litigation-docket entries. The entry-creation form 300 may be used for entering standard meeting-request information (e.g., invitees, subject, location, and start and end times) and custom information pertinent to litigation events. Such a custom entry-creation form provides a simple method for creating litigation-docket entries. The form 300 may include any of the following custom user-interface (UI) controls: a client-entry field 336, a find-client button 337, a matter-entry field 338, a find-matter button 339, a responsible-attorney-entry field 342, and various time-zone representations 322, 324, 326, and 328.

The custom entry-creation form 300 may include a most-recently-used-client combination box 332 that may be used for displaying a user's most-recently-entered client reference information, such as client-reference numbers. The find-client button 337 may be a button that links to a database of client information, such as a document-management system (e.g., Interwoven DeskSite®), for selecting client-reference information.

The custom entry-creation form 300 may include a most-recently-used-matter combination box 339 that may be used for displaying a user's most-recently-entered matter-reference information for a selected client. The find-matter button 339 may link to a database of matter information, such as a document-management system (e.g., Interwoven DeskSite®), for selection of litigation-matter-reference information.

Selecting a client and matter may automatically result in a determination of an applicable distribution group, the members of which will receive instances of the litigation-docket entry. Available distribution groups may exist in an Outlook® Global Address List (“GAL”). Such distribution groups may be displayed for selection of an appropriate distribution group by the entry creator and/or may be identified by a client-matter reference code using a custom GAL field. Similarly, if the creator of the litigation-docket entry first uses the standard Outlook® Select-Names dialog to choose a distribution group, the client and matter fields may be automatically populated. In addition, the Category field of the litigation-event request may be populated with the client-matter information.

To populate the responsible-attorney-entry field 342, the entry creator may use the find-attorney button 344 to select an attorney from an address list or a list of contacts, or the event creator may type one or more attorney names directly into the entry field 342.

The time-zone-display fields 322, 324, 326, and 328 may be read-only fields that display the start time and end time of the litigation event in multiple time zones, such as, Pacific, Mountain, Central, and Eastern.

A legend area 316 includes a “My Local Time” legend entry 318 and a “Meeting Time” legend entry 320. The legend entries may contain a visual indication, such as a color or shading that indicate to a user which time-zone representation is for the user's local time and which time-zone representation applies to the physical location of the litigation event (as is discussed in more detail below).

In accordance with embodiments of the invention, a master-litigation-docket calendar may be maintained. For instance, when an entry creator creates and saves a litigation-docket entry, a litigation-docket entry (e.g., an appointment) may be saved on a Litigation Docket public calendar (i.e., in a public folder), and also may be sent to litigation-team members in accordance with an applicable distribution group, as discussed above. Alternatively, when a user creates and saves a litigation-docket entry, instances of a litigation-docket-entry may be routed to the members of the distribution group and to a master-litigation-docket account, which may be an Exchange user and which may be referred to as the LitDocket account.

IV. Entering Litigation-Event Information

As discussed above, FIG. 3 depicts an entry-creation form 300 in accordance with embodiments of the invention. The time-zone field 302 of a litigation-docket entry may have a default value that is the same as the time zone of the entry creator's computer clock. The entry creator may specify a value for the time-zone field 302 based on the time zone of the litigation event's physical location. For a court appearance, a court-filing deadline, a discovery-response deadline, and the like, a time-zone value may be specified to be the time zone of the physical location of the Court where the litigation is pending. For a deposition, the entry creator may enter the time zone of the physical location of the deposition. In FIG. 3, the time-zone field 302 contains a value of Central Time, which is also the entry creator's default time zone.

In FIG. 3, different time-zone representations, including a Pacific-Time representation 322, a Mountain-Time representation 324, a Central-Time representation 326, and an Eastern-Time representation 328, are simultaneously displayed. In this way, the start and end times of a litigation-docket entry are automatically converted from the time zone of the litigation event into other time zones thereby providing convenient and accurate time-zone conversions. Such time-zone conversions advantageously reduce scheduling errors caused by incorrect, manually calculated, time-zone conversions.

A Start-Time field 308 and an End-Time field 310 allow an entry creator to specify the start and end times, respectively, of a litigation event. If the litigation-docket entry is for a court-filing deadline or discovery-response deadline that does not have a specific start time, the entry creator may leave the default start time at 8:00 A.M. and the length at 30 minutes. These settings will normally cause an instance of the litigation-docket entry to occupy only a single line on a litigation-team member's daily calendar.

A subject field 312 is provided into which an entry creator may enter a short descriptor of the litigation followed by a detailed description of the litigation event. A few good examples of subject-field entries are: “SB-Offensive—Hearing on summary judgment motions,” “Acme v. Jones—Deposition of John Smith,” “Acme v. Johnson—Johnson's Response to Motion to Compel Due,” and “SB-McCoy—SB's Responses to McCoy's Document Requests Due.

A location field 313 is provided into which an entry creator may enter location information to indicate where the litigation event will take place.

Case information, which identifies the litigation, may be entered into a litigation-docket entry in the form of a case number, a civil-action number, a client number, a matter number, and a docket number.

A reminder field 314 is provided. Upon receiving and accepting a litigation-docket-entry instance, a recipient may change the reminder settings for the instance of the litigation-docket entry in their own personal calendar (e.g., add a reminder or delete a reminder). A reminder change of this type will not affect reminder settings for instances of the litigation-docket entry received by other litigation-team members.

The entry-creation form 300 shown in FIG. 3 shows fields that may be used for entering reference information, such as a client code and a matter code, for a litigation-docket entry. In accordance with embodiments of the invention, client and matter numbers may be selected in any of the following ways: (1) using drop down menus 332 and 334 containing recent client-number and matter-number entries; (2) client and matter numbers may be typed into entry fields 336 and 338 by the entry creator; and (3) the find-client button 337 and find-matter button 339 may be used to select client and matter numbers from a list of available client and matter numbers. A required-attendee list may be automatically generated based on the entered client and matter information. In the event that a litigation-docket account is being maintained to keep track of litigation-docket entries, the required-attendee list may include the litigation-docket account.

The name of one or more responsible attorneys for a litigation-docket entry may be entered via a responsible-attorney text-entry field 342 and/or a find-attorneys button 344, which may be used for selecting attorney names from a list. An entry creator may enter a description of the responsibility, such as attending a deposition or court hearing or preparing a brief. A responsibility drop-down menu 346 may be used for viewing and selecting recently-entered responsibility descriptions.

The entry-creation form 300 includes UI controls for adding, removing, and/or opening links to documents, including documents stored within a document management system, such as Interwoven DeskSite®. Links to documents may be added to, and removed from, a litigation-docket entry using the Add button 352 and the Remove button 354, respectively. Adding a document link to a litigation-docket entry essentially inserts into the litigation-docket entry a pointer to the document, which may be stored in the document-management store 206. The Open button 356 may be used for opening linked-to documents, which may be performed by invoking an API call to attempt to retrieve the stored document. Depending on the document's security setting and/or the litigation-docket-system user's privilege to view and edit the document, the document management-server 210 will provide the document to the target device 212 through which a user may interact with the document.

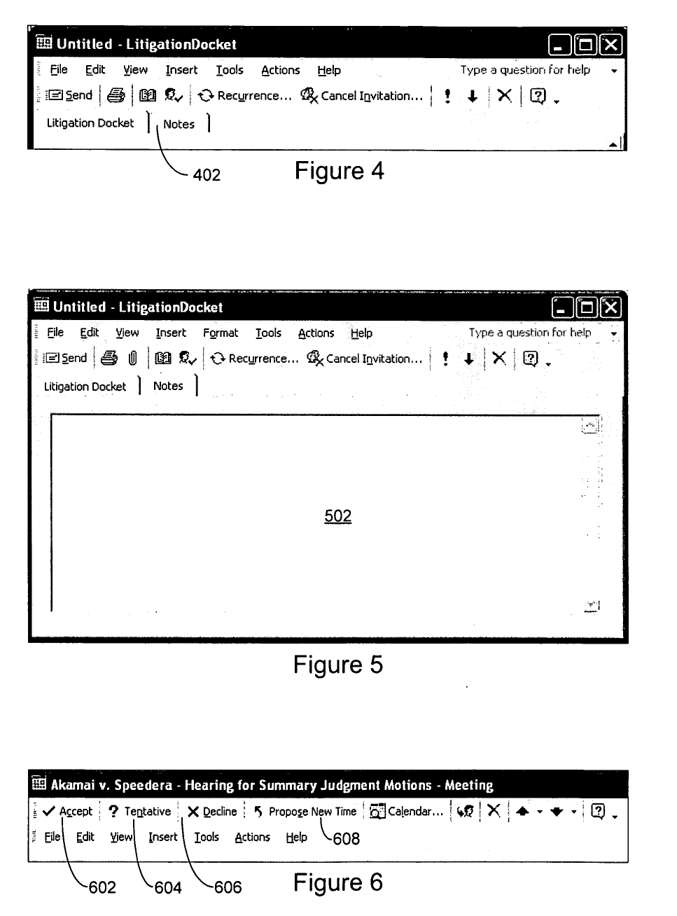

Referring to FIGS. 4 and 5, a litigation-docket entry may include a Notes field in which an entry creator may add notes to the litigation-docket entry. The Notes field may be accessed by clicking on a Notes tab 402. Text may be typed into the Notes field 502. Notes may also be entered by cutting and pasting text, e-mails, and the like into the Notes field 502. As is the case with other fields in a litigation-docket entry, a recipient of an instance of the litigation-docket entry may be denied permission to add their own notes to the Notes field 502 so that only the entry creator has permission to add notes to a litigation-docket entry. A litigation-docket administrator may also be given permission to add notes to a litigation-docket entry.

V. Receiving a Litigation-Docket-Entry Instances

In accordance with embodiments of the invention, litigation-docket-entry instances may appear in recipients' inboxes in a manner similar to standard Outlook® PIM meeting requests. Like an Outlook® PIM meeting request, a recipient of an instance of a litigation-docket entry may respond to the litigation-docket-entry instance by clicking on the Accept button 602 (FIG. 6), the Tentative button 604, or the Decline button 606. There is also a Propose New Time button 608.

In accordance with embodiments of the invention, information may be obtained from one or more fields of the entry-creation form 300 and automatically added to the subject field of a litigation-docket-entry instance received by litigation-team members. For example, assume an entry creator enters “SB-Offensive—Deposition of John Smith” in the subject field 312, “Atlanta” in the location field 313, “9:00 AM” in the start-time field 308, “001263” in the client field 336, and “00008” in the matter field 338. When disseminated instances of the litigation-docket entry are displayed on litigation-team members' computers (including the entry creator's computer), the subject field of the litigation-docket-entry instance may appear as “SB-Offensive—Deposition of John Smith (Atlanta, 9 am EST, 001263.00008).” A subject field with this type of automatically generated information (i.e., “Atlanta, 9 am EST, 001263.00008) advantageously includes the start time of the litigation event so that if a litigation-team member alters his or her own view as to time (e.g., moves the 9 am slot to an “all day event” slot), the start time of the litigation event will remain accessible to the recipient in the subject field of the received litigation-docket-entry instance.

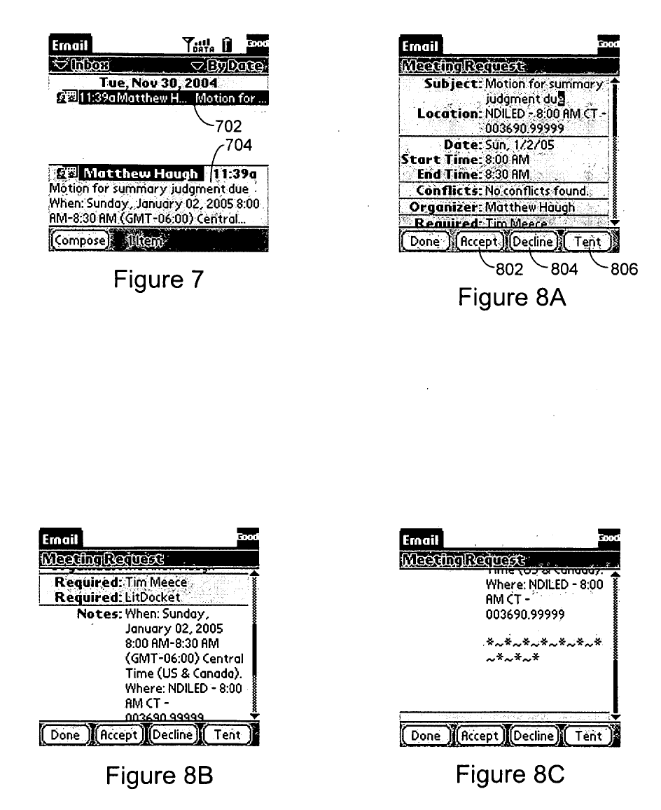

FIGS. 7 and 8A-8C are smart-phone screen shots that show a received litigation-docket entry in accordance with embodiments of the invention. FIG. 7 depicts a received litigation-docket entry that has not yet been opened. The time received, sender, and the beginning of the title of the litigation-docket entry are depicted at 702. A preview of the litigation-docket entry's content is depicted at 704. FIGS. 8A-8C depict the top, middle, and bottom, respectively, of the received litigation-docket once the entry has been opened. FIG. 8A depicts various litigation-docket entry fields, including: subject, location, date, start time, end time, organizer (also referred to herein as entry creator), and required attendees. User interface controls 802, 804, and 806 are provided for accepting, declining, or tentatively accepting the litigation-docket entry. FIG. 8B shows the following fields of the litigation-docket entry: required attendees and notes. FIG. 8C shows the bottom of the notes field and the end of the of the litigation-docket entry.

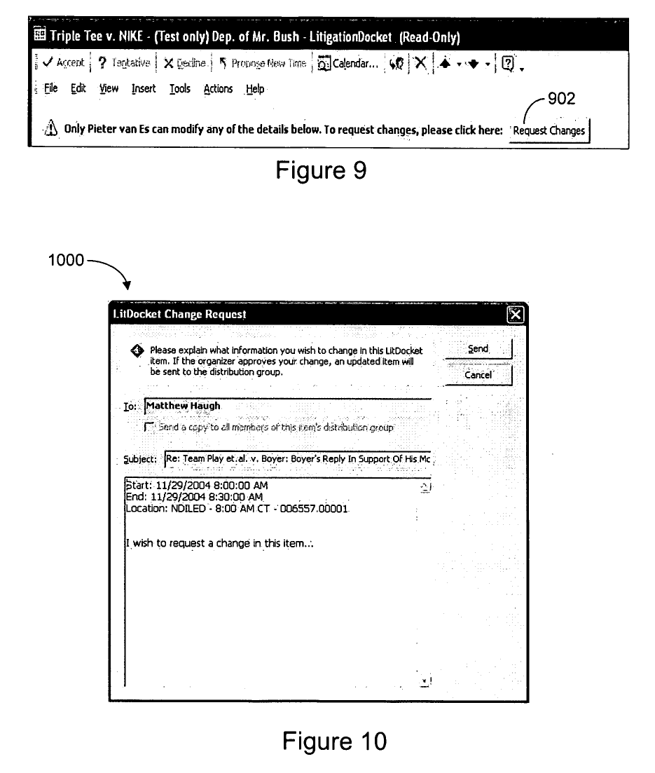

Referring to FIGS. 9 and 10, recipients of litigation-docket-entry instances may use a Request Change button 902 to instantiate a Change-Request form 1000, which may be used for requesting that the entry creator change information, such as the scheduled time or the responsible attorney, within a litigation-docket entry. FIG. 10 shows a change-request form 1000 that a recipient may send to the creator of the litigation-docket entry to request a change. The change request may be sent to a master litigation-docket account as well as to the entry creator. Then, either a litigation-docket administrator with access to the master-litigation-docket account or the entry creator may make some or all of the changes requested in the change request form. Upon such a change being made, revised litigation-docket-entry instances will be mailed to litigation-team members.

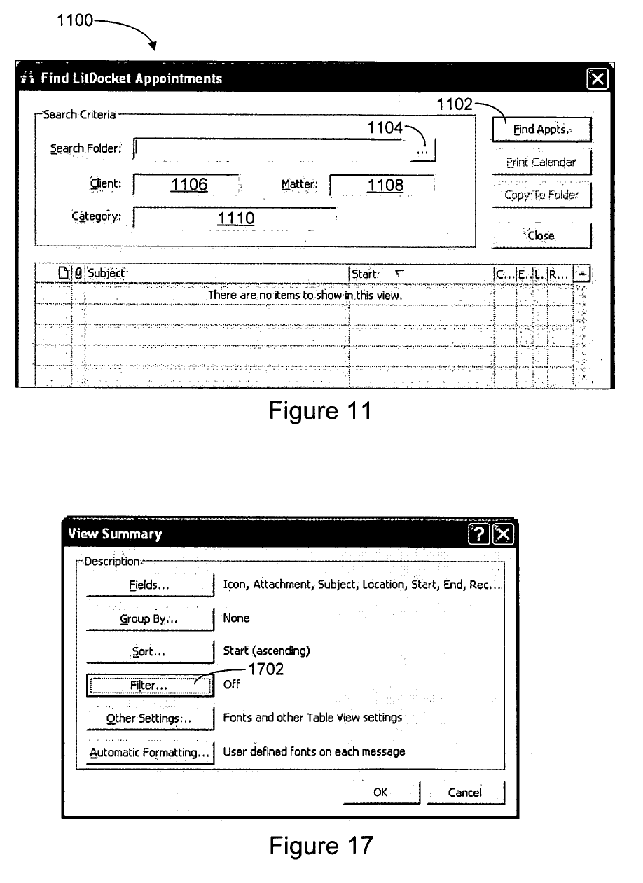

Referring to FIG. 11, a Find-Entries form 800 allows litigation-docket users to search for litigation-docket entries by clicking on the “Find Appts.” button 1102. The user may then click on the find-folder button 1104 to select a search folder, such as the user's litigation-docket calendar, the user's personal calendar, or any other user's calendar to which the user has access. A user may search for litigation-docket entries by entering client and/or matter information into the client field 1106 and/or the matter field 1108, respectively. A user may also search for litigation-docket entries by entering a client-matter number in the category field 1110. In accordance with embodiments of the invention, a litigation-docket entry's category is automatically generated and contains a client-matter number, such as 005227.00010.

VI. Verification of Litigation-Docket-Entry Instances

A verification utility may be used to verify that litigation-team members (and the LitDocket account) have litigation-docket-entry instances that are consistent with one another. Each instance of a litigation-docket entry that corresponds to a particular litigation event (e.g., LitDocket account's instance, the entry creator's instance, and the recipients' instances) may have a common identifier, referred to as a LitDocket ID, which uniquely identifies such litigation-docket-entry instances relative to instances of other litigation-docket entries.

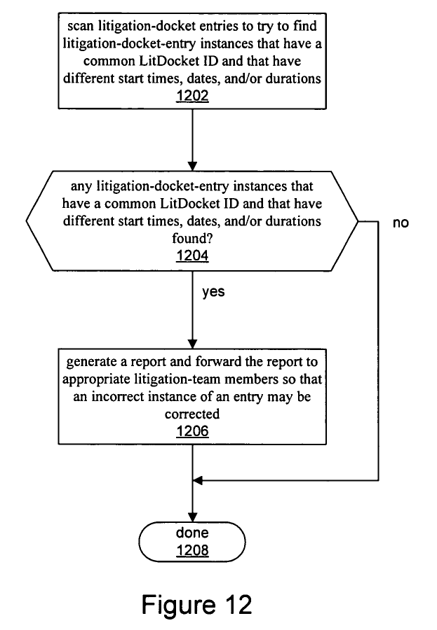

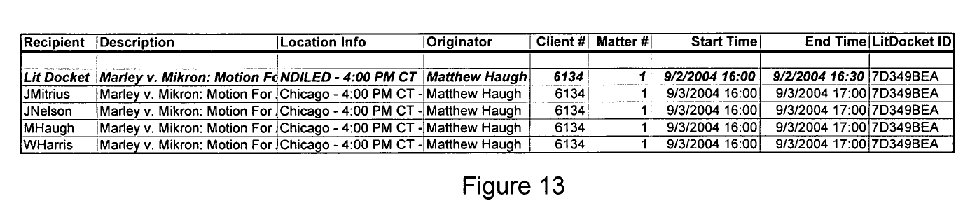

As depicted at step 1202 in FIG. 12, the verification utility may scan litigation-docket entries to try to find litigation-docket-entry instances that have a common LitDocket ID and that have different start times, dates, and/or durations. A discrepancy of this type may be caused by a litigation-docket user dragging and dropping an instance of a litigation-docket entry to an incorrect time-slot in the user's calendar. For instance, FIG. 13 depicts a report generated by the verification utility in which five litigation-docket-entry instances each occupy a row of the report and share a common LitDocket ID, namely, 7D349BEA. The recipients of the five docket-entry instances in the report of FIG. 13 are the LitDocket account, JMitrius, JNelson, MHaugh, and WHarris. The date of the Start-Time field for the LitDocket-account instance is 9/2/2004, which is different than the date of the Start-Time field (i.e., 9/3/2004) of the remaining four litigation-docket-entry instances in the report. When an out-of-sync situation of this type is found, a report may be generated and forwarded to appropriate litigation-team members so that an incorrect instance of an entry may be corrected, as depicted by the “yes” branch from decision step 1204 and by step 1206. Otherwise, if no such out-of-sync condition is detected, no report of this type is generated, as depicted by the “no” branch from decision step 1204. Verification-utility processing is then finished, as depicted at step 1208.

The verification utility may be run periodically (e.g., weekly) to check for inconsistent litigation-docket-entry instances. The utility may accept a date range of litigation-docket-entry instances to be verified. A default start date may be the current date, and a default end date may be one month in the future. The program may search substantially all calendars within multiple server computers without having to manage a list of calendars to search. The program may copy substantially all entries with a valid LitDocket ID within the specified date range to a data structure, such as a SQL Server table, so that in-depth querying may be performed during a second pass. The data structure may include one or more of the following fields: message ID, start date/time, end date/time, mailbox name, meeting subject, meeting location, meeting organizer, LitDocket ID, client ID, and matter ID.

VII. Docketing Litigation Information for a Litigation Event

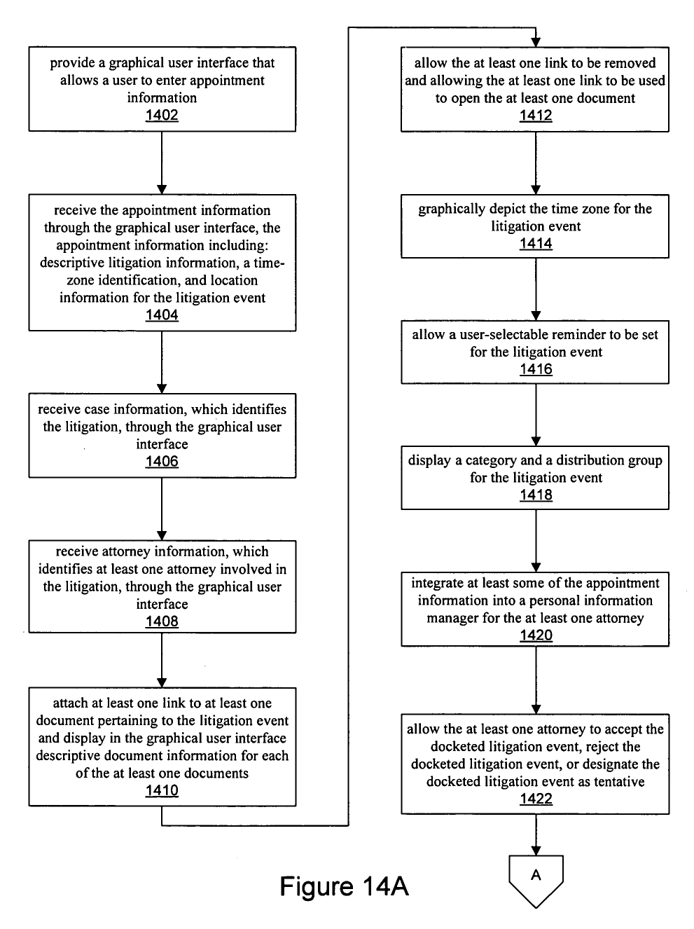

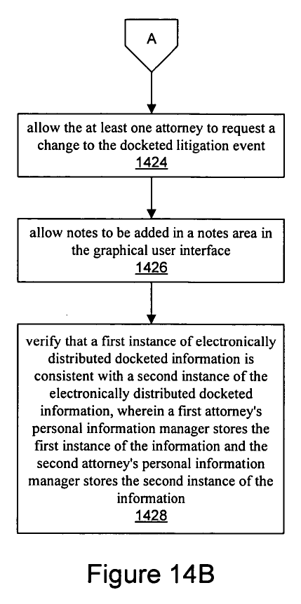

FIGS. 14A and 14B depict a flowchart of exemplary steps for docketing litigation information for a litigation event in accordance with embodiments of the invention. A graphical user interface, which allows a user to enter appointment information, is provided, as shown at step 1402.

Appointment information is received by the litigation-docket system 200, via user input, through the graphical user interface, wherein the appointment information includes: descriptive litigation information, a time-zone identification, and location information for the litigation event, as shown at step 1404.

Case information, which identifies the litigation, is received by the litigation-docket system 200, via user input, through the graphical user interface, as shown at step 1406. Attorney information, which identifies at least one attorney involved in the litigation, is received by the litigation-docket system 200, via user input, through the graphical user interface, as shown at step 1408.

At least one link to at least one document pertaining to the litigation event is attached and descriptive document information for each of the at least one documents is displayed in the graphical user interface, as shown at step 1410.

The at least one link is allowed to be removed and the at least one link is allowed to be used to open the at least one document, as shown at step 1412.

The time zone for the litigation event is graphically depicted, as shown at step 1414. A user-selectable reminder is allowed to be set for the litigation event, as shown at step 1416.

A category and a distribution group for the litigation event are displayed, as shown at step 1418. At least some of the appointment information is integrated into a personal information manager for the at least one attorney, as shown at step 1420.

The at least one attorney is allowed to accept the docketed litigation event, reject the docketed litigation event, or designate the docketed litigation event as tentative, as shown at step 1422.

The at least one attorney is allowed to request a change to the docketed litigation event, as shown at step 1424.

Notes are allowed to be added in a notes area in the graphical user interface, as shown at step 1426.

Consistency between a first instance of electronically distributed docketed information and a second instance of the electronically distributed docketed information is verified, wherein a first attorney's personal information manager stores the first instance of the information and the second attorney's personal information manager stores the second instance of the information, as shown at step 1428.

VIII. Customized View of Litigation-Docket Entries

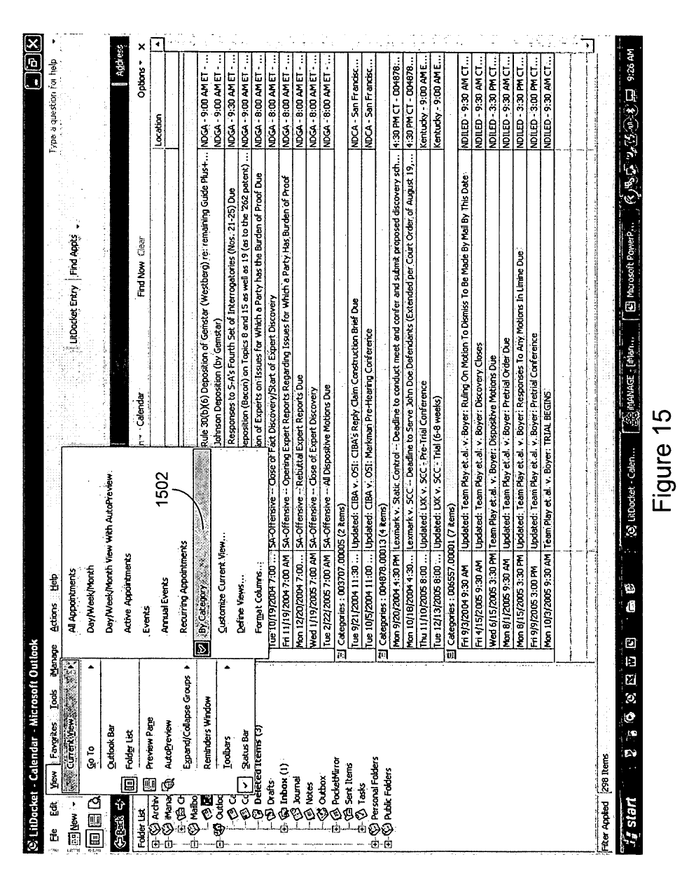

In accordance with embodiments of the invention, a user may customize the user's view of their litigation-docket entries. FIGS. 15-28 are example screen shots showing how a user can customize their view of their litigation-docket entries. The user input shown in FIGS. 15-28 result in display of a user's litigation-docket entries that: start on or after the current date, are grouped by client-matter number, and are sorted chronologically within each group of entries for a particular client-matter number. As will be apparent, a user's view of their litigation-docket entries may be customized in other ways. For example, the fields to be displayed are user-selectable and/or removable. Different views may be selected, and a user's preferred settings may be stored so that the user's litigation-docket entries will be consistently presented according to the user's preferences.

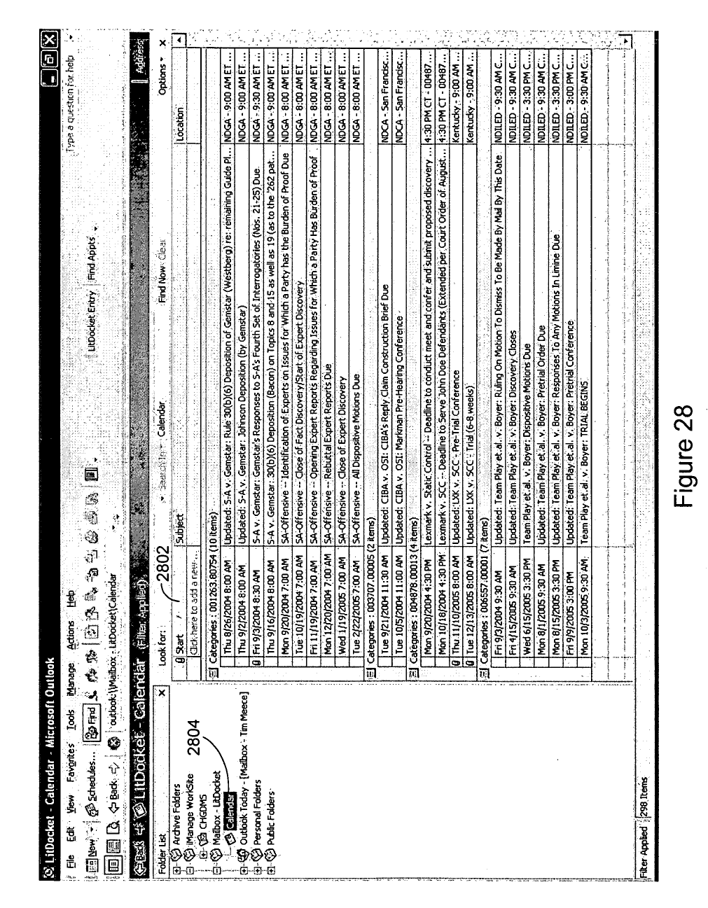

A user may click on the Litigation-Docket-Calendar folder-list entry 2804 (FIG. 28), to display the user's litigation-docket entries, such as the litigation-docket entries shown in FIG. 15. A user may select the By Category menu item 1202 to group litigation-docket entries by client-matter number.

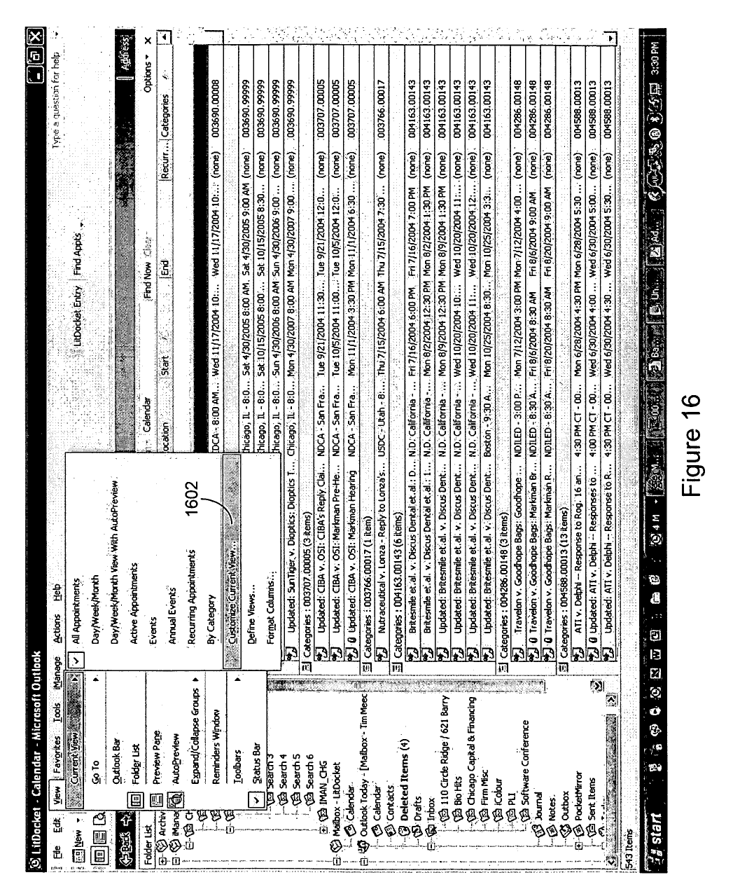

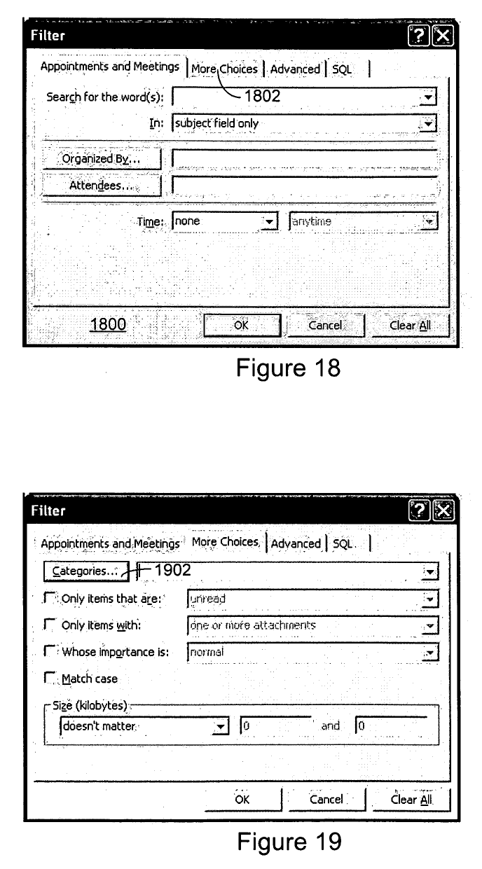

Referring to FIG. 16, a user may click on the Customize Current View menu item 1602 to bring up a UI form for customizing the user's view of their litigation-docket entries. FIG. 17 depicts such a form, which includes a filter button 1702. Clicking the filter button 1702 will result in a Filter UI form 1800 (FIG. 18) being displayed. The user then clicks the More-Choices tab 1802 and the Categories button 1902 (FIG. 19).

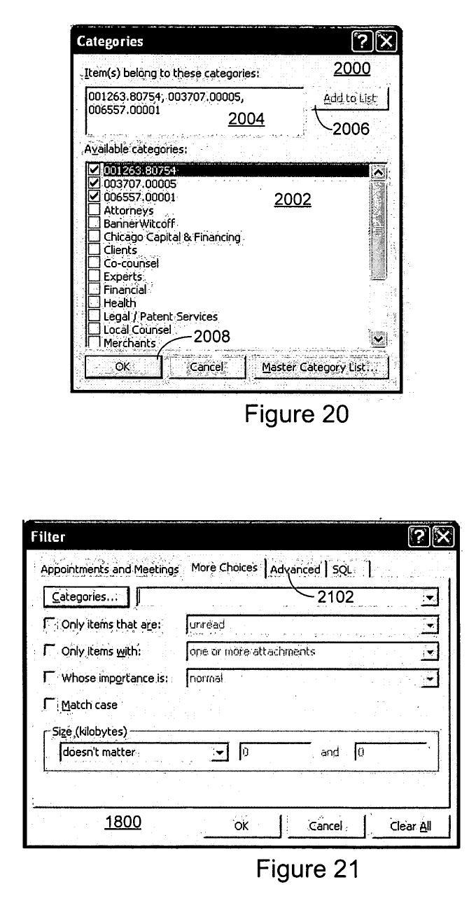

FIG. 20 depicts a Categories UI form 2000 that includes an Available-Categories area 2002 and a Selected-Categories area 2004. A user may type categories directly into the Selected-Categories area 2004. The user may also click on check boxes in the Available-Categories area 2002 and then click on the Add-to-List button 2006 to insert categories into the Selected-Categories area 2004. The user then clicks the OK button 2008, which results in the Filter UI form 1800 being displayed again.

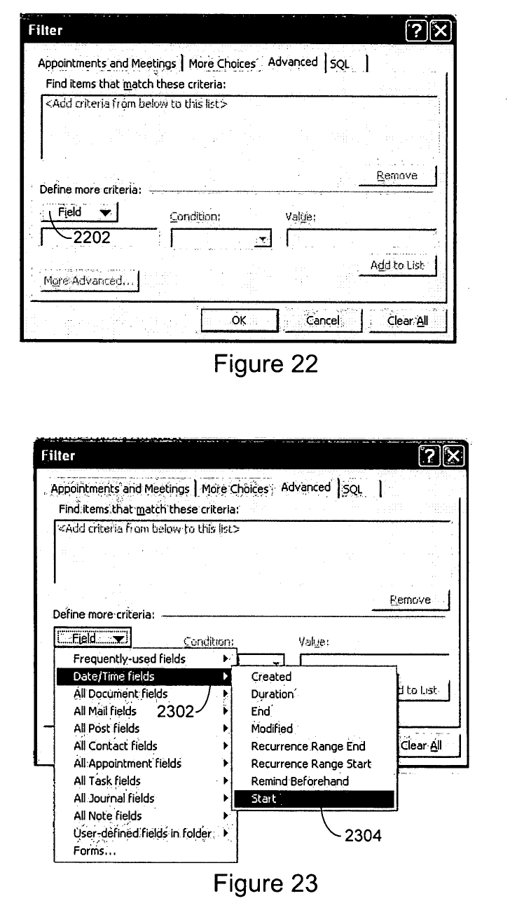

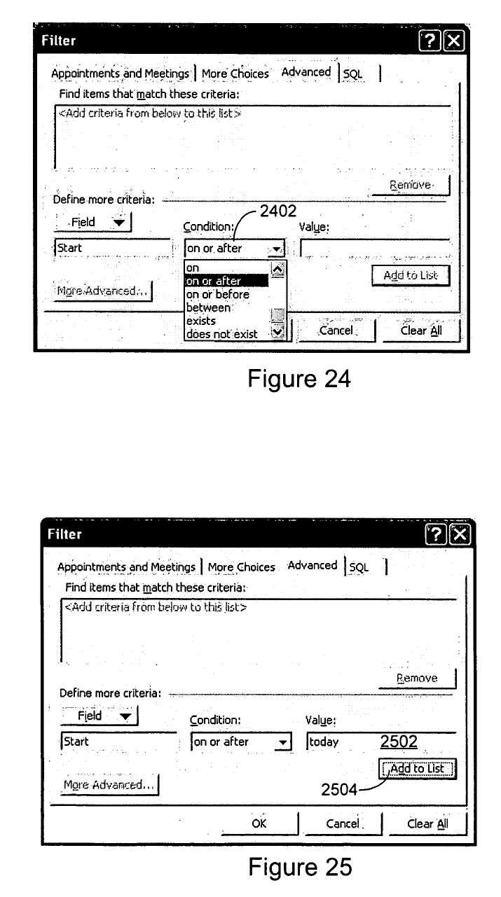

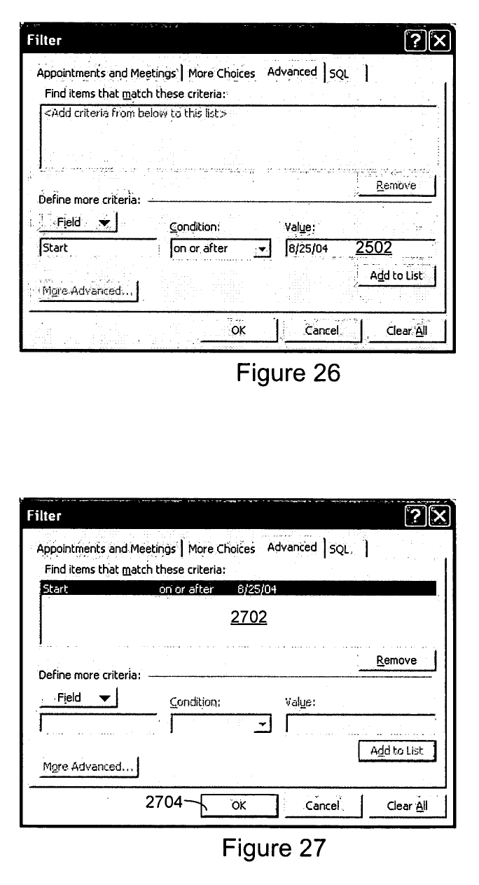

The user then clicks the Advanced tab 2102 (FIG. 21) and the Field button 2202 (FIG. 22). The user then clicks on the Date/Time fields drop-down-menu item 2302 and the Start menu item 2304. “On or After” is entered into the Condition field 2402 (FIG. 24); “today” or a date, such as “8/25/04” (FIG. 26) is entered into the Value field 2502 (FIG. 25); and then the Add-to-List button 2504 is clicked.

Entry of the date “8/25/04” into the Value field 2502 results in the Find-items-that-match-these-criteria field 2702 being populated with the condition of “start on or after 8/25/04” as shown in FIG. 27. The user then clicks the OK button 2704. Then, when the user views their litigation-docket entries, only litigation-docket entries with start dates on or after 8/25/04 will be displayed, as in FIG. 28, and the entries will be grouped by category, such as client-matter number. The displayed litigation-docket entries may be sorted within each category by their start dates, as are the entries shown in FIG. 28, by clicking on the start-date column heading 2802.

IX. Concluding Remarks

What has been described above is merely illustrative of the application of the principles of the invention. Those skilled in the art can implement other arrangements and methods without departing from the spirit and scope of the invention. Any of the methods of the invention can be implemented in software that can be stored on computer disks or other computer-readable media.

We Claim:

1) A method in a computer system for docketing litigation information for a litigation event, the method comprising:
a) providing a graphical user interface that allows a user to enter appointment information;
b) receiving the appointment information through the graphical user interface, the appointment information including:
i) descriptive litigation information that identifies the litigation event,
ii) time information that identifies a start time for the litigation event,
iii) date information that identifies a start date for the litigation event,
iv) a time-zone identification that identifies a time zone for the litigation event, and
v) location information that identifies a location for the litigation event;
c) receiving case information through the graphical user interface, wherein the case information identifies the litigation; and
d) receiving attorney information through the graphical user interface, wherein the attorney information identifies at least one attorney involved in the litigation.

2) The method of claim 1 further comprising:
a) attaching at least one link to at least one document pertaining to the litigation event; and
b) displaying in the graphical user interface descriptive document information for each of the at least one documents.

3) The method of claim 2 further comprising: allowing the at least one link to be removed.

4) The method of claim 2 further comprising: allowing the at least one link to be used to open the at least one document.

5) The method of claim 3 wherein the descriptive document information includes one or more document fields selected from the group consisting of: client, client number, matter, matter number, description, title, and document date.

6) The method of claim 1 wherein the case information is selected from the group consisting of: a case number, a civil action number, a client number, a matter number, and a docket number.

7) The method of claim 1 further comprising: graphically depicting the time zone for the litigation event.

8) The method of claim 1 further comprising: allowing a user-selectable reminder to be set for the litigation event.

9) The method of claim 1 further comprising: displaying a category for the litigation event.

10) The method of claim 1 further comprising: displaying a distribution group for the litigation event.

11) The method of claim 1 further comprising: integrating at least some of the appointment information into a personal information manager for the at least one attorney.

12) The method of claim 11 wherein the personal information manager is Microsoft® Outlook®.

13) The method of claim 11 further comprising: allowing the at least one attorney to accept the docketed litigation event, to reject the docketed litigation event, or to designate the docketed litigation event as tentative.

14) The method of claim 13 further comprising: allowing the at least one attorney to request a change to the docketed litigation event.

15) The method of claim 1 further comprising: allowing notes to be added in a notes area in the graphical user interface.

16) The method of claim 11, wherein the method is implemented as computer-executable instructions stored on a computer-readable medium.

17) A method in a computer system for docketing litigation information for a litigation event, the method comprising:
a) providing a graphical user interface that allows a user to enter appointment information;
b) receiving the appointment information through the graphical user interface, the appointment information including:
i) descriptive litigation information that identifies the litigation event,
ii) time information that identifies a start time for the litigation event,
iii) date information that identifies a start date for the litigation event,
iv) a time-zone identification that identifies a time zone for the litigation event, and
v) location information that identifies a location for the litigation event;
c) receiving case information through the graphical user interface, wherein the case information identifies the litigation and is selected from the group consisting of: a case number, a civil action number, a client number, a matter number, and a docket number;
d) receiving attorney information through the graphical user interface, wherein the attorney information identifies at least one attorney involved in the litigation;
e) allowing a user-selectable reminder to be set for the litigation event; and
f) integrating at least some of the appointment information into a personal information manager for each of the at least one attorneys.

18) The method of claim 17, wherein the method is implemented as computer-executable instructions stored on a computer-readable medium.

19) A method in a computer system for docketing litigation information for a litigation event, the method comprising:
a) providing a graphical user interface that allows a user to enter appointment information;
b) receiving the appointment information through the graphical user interface, the appointment information including:
i) descriptive litigation information that identifies the litigation event,
ii) time information that identifies a start time for the litigation event,
iii) date information that identifies a start date for the litigation event,
iv) a time-zone identification that identifies a time zone for the litigation event, and
v) location information that identifies a location for the litigation event;
c) receiving case information in the graphical user interface, wherein the case information identifies the litigation and is selected from the group consisting of: a case number, a civil action number, a client number, a matter number, and a docket number;
d) receiving attorney information in the graphical user interface, wherein the attorney information identifies at least one attorney involved in the litigation;
e) allowing at least one link to be attached to at least one document pertaining to the litigation event;
f) allowing the at least one link to be removed;
g) allowing the at least one link to be used to open the at least one document;
h) displaying in the graphical user interface descriptive document information for each of the at least one documents, the descriptive document information being selected from the group consisting of client information, a client number, matter information, a matter number, a description of the at least one document, a title of the at least one document, a date of the at least one document, a represented party, and a pleading identifier;
i) graphically depicting the time zone for the litigation event;
j) allowing a user-selectable reminder to be set for the litigation event;
k) allowing each of the at least one attorneys to accept the docketed litigation event, to reject the docketed litigation event, or to designate the docketed litigation event as tentative; and
l) integrating at least some of the appointment information into a personal information manager for each of the at least one attorneys who have accepted the docketed litigation event.

20) The method of claim 19 further comprising: electronically distributing the docketed litigation information to each of the at least one attorneys who is involved in the litigation.

21) The method of claim 20, wherein the method is implemented as computer-executable instructions stored on a computer-readable medium.

22) The method of claim 20, further comprising: verifying that a first instance of the electronically distributed docketed information is consistent with a second instance of the electronically distributed docketed information, wherein the at least one attorney includes at least a first attorney and a second attorney and wherein the first attorney's personal information manager stores the first instance of the electronically distributed docketed information and the second attorney's personal information manager stores the second instance of the electronically distributed docketed information.

23) A system that disseminates litigation-docket information regarding a litigation event, the system comprising:
a) a source-data repository that stores a document that pertains to the litigation event; and
b) a personal information manager that is updated based on the disseminated litigation-docket information, wherein the disseminated litigation-docket information includes a link to the document stored in the source-data repository.

24) The system of claim 23, wherein, upon a user activating the link to the document, the system attempts to retrieve the document from the data repository and to present the document to the user.

25) The system of claim 23, wherein the personal information manager provides a graphical user interface that allows a user to enter information about the litigation event.

26) The system of claim 25, wherein the graphical user interface comprises a time-zone field that receives, as input from the user, a time-zone identification that identifies a time zone for the litigation event.

27) The system of claim 25, wherein the graphical user interface comprises a responsible-attorney field that receives, as input from the user, attorney information that identifies at least one attorney that is responsible for the litigation event.

28) The system of claim 23, wherein a start time of the litigation event is automatically added to a subject field of the disseminated litigation-docket information.
